(19) United States
(12) Patent Application Publication
(10) Pub. No.: US 2014/0255658 A1
(43) Pub. Date: Sep. 11, 2014

(54) ROBUST ELASTOMERIC MATERIALS

(71) Applicant: Clopay Plastics Products Company, Inc., Mason, OH (US)

(72) Inventors: Iyad Muslet, Mason, OH (US); Jean Philippe Marie Autran, Cincinnati, OH (US); Janet Neton, West Chester, OH (US); David G. Bland, Mason, OH (US)

(73) Assignee: Clopay Plastics Products Company, Inc., Mason, OH (US)

(21) Appl. No.: 14/204,104

(22) Filed: Mar. 11, 2014

Related U.S. Application Data
(60) Provisional application No. 61/775,954, filed on Mar. 11, 2013.

(51) Int. Cl. B32B 7/12; B32B 37/02; B32B 7/02

(52) U.S. Cl. CPC B32B 7/12; B32B 7/02; B32B 37/02
USPC 428/189; 156/182

(57) ABSTRACT

A thin elastomeric laminate can be made by bonding two bilaminate precursors. The bilaminate precursors are made from a thin elastomeric film laminated to a thin nonwoven fabric. Two layers of bilaminate precursor are then bonded such that the free film faces of both precursors are facing one another. The resulting laminates exhibit good robustness and resist the formation of activation pinholes.

### FIELD OF THE INVENTION

The present invention relates to thin elastomeric films laminated to nonelastomeric materials, such as fabrics, where the resulting laminates are elastomeric, inexpensive and robust. The present invention also relates to methods of making thin laminates of elastomeric films and nonelastomeric materials, where the resulting laminates are elastomeric, inexpensive, and robust.

### BACKGROUND OF THE INVENTION

Elastomeric materials stretch to fit over or around a larger object, and then retract to provide a snug fit around the object. For instance, elastomeric materials are used in garments to conform to the body and provide a snug fit, such as in active wear. Snug fit is especially important in hygienic products such as diapers, to prevent body fluid leakage. Elastomers can also form resilient but effective barriers, such as in the cuffs of thermal garments in order to retain body heat.

In a garment, the elastomer can be in the form of threads, fabrics, or films. Using elastomeric threads can pose challenges in assembling the garment, since the threads must be applied as one component of many in the manufacturing process. Elastomeric fabrics are somewhat easier to work with in a manufacturing process, but the fabrics themselves tend to be expensive both in raw materials and in the cost of manufacturing the fabric itself. Elastomeric films are typically easier to use in manufacturing than threads and are less expensive than elastomeric fabrics.

However, a disadvantage of an elastomeric film is that the film tears easily if the film is cut, notched or perforated. This is particularly true of elastomeric polymers comprising styrene block copolymers (SBCs), such as styrene-butadiene-styrene block copolymer. Elastomeric films are especially prone to tearing in the film's machine direction, possibly due to the orientation of the elastomeric polymer molecules during film extrusion. Manufacturers must often use relatively thick elastomeric films, with basis weights of about 50-100 grams per square meter (gsm) or more, to prevent the formation of nicks or pinholes which can initiate film tearing.

To give the elastomeric film a more pleasant, cloth-like feel and appearance, to strengthen the film, and to reduce film blocking, it is known in the art to cover the elastomeric film with fabric or fabric-like material. For instance, elastomeric films used in limited-use or disposable garments may be bonded or laminated to layers of nonwoven, woven, or knitted fabric, so the fabric covers the elastomeric film and contacts the wearer's skin. For disposable hygienic products such as diapers, nonwoven fabrics are preferred because of their low cost. Also, nonwoven fabric is frequently laminated to both sides of the elastomeric film, to provide the pleasant cloth-like texture on each side and avoid the sticky feel of the bare elastomeric film. The elastomeric film can be bonded or laminated to fabrics by various known means, including extrusion lamination, adhesive lamination, thermal lamination, and ultrasonic lamination.

The fabrics used for disposable items are typically nonwoven fabrics made from inexpensive materials such as polypropylene or polyethylene. Most inexpensive nonwovens are not elastomeric, though. This means that a laminate formed from an elastomeric film directly bonded coextensively to one or more layers of inelastic nonwoven does not stretch, either. Such laminates must be treated in some manner in order to make them elastomeric.

There are several ways to make an elastic film/inelastic nonwoven laminate stretchable. For instance, one layer of the laminate (either the film or the nonwoven) may be prestretched prior to bonding the layers. This method is expensive and capital-intensive, requiring a lot of equipment and several manufacturing steps.

Another way to make an elastomeric laminate that is stretchable is to use a highly extensible nonwoven, such as a spunlace nonwoven. Spunlace nonwovens are made by entangling the fibers, instead of thermally or adhesively bonding the fibers. The fibers in a spunlace nonwoven are free to slip past one another when bonded to an elastomeric film and the laminate is stretched. Unfortunately, spunlace nonwovens tend to be significantly more expensive than thermally- or adhesively-bonded nonwovens like spunbond polypropylene.

Yet another way to render an elastomeric film/inelastic nonwoven laminate stretchable is to stretch or “activate” the laminate after it has been formed. Incremental stretching, described in the commonly assigned U.S. Pat. No. 5,422,172, is a particularly useful method for activating an elastomeric laminate to render the laminate stretchable. Activation stretches or breaks the fibers of the nonwoven layers, and renders the laminate stretchable. Activated elastomeric laminates tend to be less expensive to manufacture than other stretchable elastomeric laminates.

Unfortunately, the activation process itself can create problems. When an elastomeric laminate is activated, tiny pinholes can form due to the high stretching forces concentrated on the laminate, especially where the nonwoven fibers bond directly to the elastic film. Not surprisingly, activation pinholes are a greater problem for thinner films. To reduce costs, manufacturers want to use the thinnest possible film, but the problem of activation pinholes may require a manufacturer to use a thicker film than would otherwise be necessary.

Activation pinholes can be a problem because they may allow fluids to leak through the laminate. This is a particular problem with hygienic products such as diapers. Also, as discussed above, elastic films tend to tear easily if the film has a cut or hole in it. A pinhole in an elastomeric laminate can initiate a tear, and the tearing happens rapidly if the laminate is stretched under tension. Therefore, pinholes can cause the laminate to break when it has been stretched only a small amount, which leads to the material having a low percent strain at break. This is an especially serious problem when the pinholes are more frequent. If there are pinholes in, for instance, 10 percent of the laminate at a given film basis weight, then the manufacturer might expect 10% of the products using the laminate will experience breakage of the laminate at a low strain. The remaining 90% of the products may perform properly, but a 10% failure rate is unacceptable. Therefore, the manufacturer must produce a product that has a thicker, more robust, and more expensive film than is otherwise necessary, in order to prevent the failure experienced by the minority of samples that might have pinholes at a lower film basis weight.

There remains a need for a robust but inexpensive elastomeric laminate that resists tearing and the formation of pinholes. Such a film or laminate would be suitable for improving the fit and comfort of garments and personal care items, including limited-use and disposable items.

### SUMMARY OF THE INVENTION

In one embodiment, the present invention is directed to a laminate comprising two bilaminate precursors, each comprising a thin elastomeric film bonded to a substrate layer, such as a layer of fabric, where the two bilaminate precursor layers are bonded by an adhesive layer between the film surfaces facing one another.

In another embodiment, the present invention is directed to a laminate comprising two bilaminate precursors, each bilaminate precursor comprising a thin elastomeric film bonded to a substrate layer, such as a layer of fabric, where the two bilaminate precursor layers are then bonded by an extruded polymer layer between the film surfaces facing one another.

In another embodiment, the present invention is directed to a laminate comprising two bilaminate precursors of identical composition, each bilaminate precursor comprising a thin elastomeric film bonded to a layer of fabric, where the two bilaminate precursor layers are bonded by an adhesive layer or an extruded polymer layer between the film surfaces facing one another.

In yet another embodiment, the present invention is directed to a laminate comprising two bilaminate precursors of different compositions, each bilaminate precursor comprising a thin elastomeric film bonded to a layer of fabric, where the two bilaminate precursor layers are bonded by an adhesive layer or an extruded polymer layer between the film surfaces facing one another.

In another embodiment, the present invention is directed to a laminate comprising two bilaminate precursors, each bilaminate precursor comprising a thin multilayer elastomeric film bonded to a layer of fabric, where the two bilaminate precursor layers are bonded by an adhesive layer or an extruded polymer layer between the film surfaces facing one another.

In yet another embodiment, the present invention is directed to a laminate comprising two bilaminate precursors, each bilaminate precursor comprising a thin multilayer film, comprising an elastomeric layer and a plastoelastomeric layer, bonded to a layer of fabric, where the two bilaminate precursors are bonded by an adhesive layer or an extruded polymer layer between the film surfaces facing one another.

In some embodiments of the present invention, the two bilaminate precursors each comprise a three layer co-extruded film (A₁BA₂) that is extrusion laminated to a nonwoven, where the A₁ tie layer and the A₂ skin layer are the plastoelastomeric outer layers, the B layer is the inner elastomeric layer. The combination of the two bilaminates with an adhesive layer C₁ creates a multilayered structure NW-A₁B₁A₂C₁A₂B₁A₁-NW as depicted in FIG. 6.

In some embodiments of the present invention, the multilayer structure may comprise two bilaminates with five layer coextruded films (ABCBA), where “A” are plastoelastic outer layers, “B” are the inner elastomeric layers, C₁ is an additional polymeric layer. The two bilaminates are then combined with an adhesive layer, C₂, to create the multilayered structure NW-A₁B₁C₁B₂A₂C₂A₂B₂C₁B₁A₁-NW, as depicted in FIG. 7.

In some embodiments of the present invention, the two bilaminate precursors are bonded into a laminate that is activated by incremental stretching, where the dual bilaminate material has more consistent tensile properties than a comparable laminate comprising a single film bonded to two nonwoven layers.

In other embodiments of the present invention, one of the bilaminate precursors is pre-strained or pre-activated by incremental stretching prior to combining this first bilaminate precursor to the other bilaminate precursor, and activating the entire material again in the same direction. This embodiment may be performed after allowing the pre-strained bilaminate precursor to fully or partially relax. It may also be performed with the pre-strained bilaminate precursor layer being held in full extension during the lamination process. The latter scenario would build high recovery. In this way, the stretch response of the two bilaminate may be tailored, as the two layers will respond differently to subsequent loading.

The inventive laminate is robust, resistant to activation pinholes, stretchable and recoverable. In other embodiments of the present invention, methods of making such robust thin elastomeric laminates are given.

Other embodiments of the invention will be apparent in view of the following detailed description of the invention.

### BRIEF DESCRIPTION OF THE DRAWINGS

The invention will be more fully understood in view of the drawings, in which:

FIG. 1 is a schematic of a typical cast extrusion process;

FIG. 2 is a schematic of a typical adhesive lamination process;

FIGS. 3a-3c show several schematics of bilaminate precursors used for the present invention.

FIG. 4 is a schematic of one embodiment of the inventive laminate;

FIG. 5 is a schematic of another embodiment of the inventive laminate;

FIG. 6 is a schematic of another embodiment of the inventive laminate;

FIG. 7 is a schematic of another embodiment of the inventive laminate;

FIG. 8 is a schematic of another embodiment of the inventive laminate;

FIG. 9 is a schematic of another embodiment of the inventive laminate.

### DETAILED DESCRIPTION OF THE INVENTION

The inventors have discovered that a bilaminate precursor, comprising one thin elastomeric film bonded to one substrate such as a nonwoven fabric, can be bonded to another precursor bilaminate to create a multi-layer elastomeric laminate. This laminate is surprisingly robust, having excellent tear resistance, pinhole resistance, and other property benefits. The inventive elastomeric laminate can be activated by known means, resists forming activation pinholes, and remains robust after activation. The inventive elastomeric laminates and methods of making such elastomeric laminates are disclosed herein.

For the purpose of this disclosure, the following terms are defined:

“Film” refers to material in a sheet-like form where the dimensions of the material in the x (length) and y (width) directions are substantially larger than the dimension in the z (thickness) direction. Films have a z-direction thickness in the range of about 1 μm to about 1 mm, which corresponds to about 0.9 to 1000 gsm for many elastomeric films.

“Thin film,” for the purpose of this patent application, refers to any film that is less than 40 gsm, preferably less than 30 gsm.

“Basis weight” is an industry standard term that quantifies the thickness or unit mass of a film or laminate product. The basis weight is the mass per planar area of the sheet-like material. Basis weight is commonly stated in units of grams per square meter (gsm) or ounces per square yard (osy).

“Coextrusion” refers to a process of making multilayer polymer films. When a multilayer polymer film is made by a coextrusion process, each polymer or polymer blend comprising a layer of the film is melted by itself. The molten polymers may be layered inside the extrusion die, and the layers of molten polymer films are extruded from the die essentially simultaneously. In coextruded polymer films, the individual layers of the film are bonded together but remain essentially unmixed and distinct as layers within the film. This is contrasted with blended multicomponent films, where the polymer components are mixed to make an essentially homogeneous blend or heterogeneous mixture of polymers that are extruded in a single layer.

“Blocking” refers to the phenomenon of a material sticking to itself while rolled, folded, or otherwise placed in intimate surface-to-surface contact, due to the inherent stickiness or tackiness of one or more of the material components. Blocking can be quantified by ASTM D3354 “Blocking Load of Plastic Film by the Parallel Plate Method.”

“Skin layer” refers to an outer layer of a coextruded, multilayer film that acts as an outer surface of the film during its production and subsequent processing.

“Tie Layer” refers to an outer layer of a coextruded, multilayer film that acts as an intermediary layer between an inner layer of film and another material, such as a nonwoven fabric, that have little chemical affinity. The composition or properties of the tie layer are such that the tie layer can bond both the inner film and the other material, thus improving the bond strength of the film/nonwoven laminate. For the purpose of this patent application, a tie layer is substantially continuous over the surface of the coextruded film, and the tie layer contains no more than 2% of a tackifier resin (and is therefore not an adhesive).

“Laminate” as a noun refers to a layered structure of sheet-like materials stacked and bonded so that the layers are substantially coextensive across the width of the narrowest sheet of material. The layers may comprise films, fabrics, other materials in sheet form, or combinations thereof. For instance, a laminate may be a structure comprising a layer of film and a layer of fabric bonded together across their width such that the two layers remain bonded as a single sheet under normal use. A laminate may also be called a composite or a coated material. “Laminate” as a verb refers to the process by which such a layered structure is formed.

“Bilaminate precursor” refers to a two-layer laminate comprising one elastomeric film bonded to one nonwoven fabric. Bilaminate precursors are later used to form the inventive elastomeric laminate.

“Extrusion lamination” or “extrusion coating” refer to processes by which a film of molten polymer is extruded onto a solid substrate, in order to coat the substrate with the molten polymer film and bond the substrate and film together.

“Extrusion bonded laminate” or EBL refers to a laminated composite formed by extrusion lamination.

“Adhesive” refers to compositions comprising one or more thermoplastic polymers, one or more tackifier resins, and other optional additives. Adhesives contain 2% or more of tackifier resin. An adhesive is generally used to join or bond two or more materials together by applying the adhesive to at least one material and bringing it into contact under sufficient pressure with at least one other material. Adhesives can be applied substantially continuously over the surface of one or more materials, or they may be applied as spaced-apart stripes, dots, swirls, random lines, or other discontinuous patterns to the material(s).

“Adhesive lamination” refers to processes by which layers of sheet-like materials are bonded together coextensively using an adhesive layer between the laminate layers. The sheet-like materials may be any solid substrate, such as polymer films, fabrics, etc. Specifically, the sheet-like materials may be bilaminate precursors.

“Chemical affinity” refers to the nature of the chemical interaction between polymers. One way to guage the chemical affinity between two polymers is to compare their solubility parameters. Two polymers are considered to have a low degree of chemical infinity if the difference in their solubility parameters is 2.5 MPa^{0.5} or greater; conversely, two polymers have a high degree of chemical affinity if the difference in their solubility parameters is less than 1.5 MPa^{0.5}.

“Elastomeric” or “elastomer” refer to polymer materials which can be stretched to at least about 150% or more of their original dimension, and which then recover to no more than about 120% of their original dimension in the direction of the applied stretching force. For example, an elastomeric film that is 10 cm long should stretch to at least about 15 cm under a suitable stretching force, and then retract to no more than about 12 cm when the stretching force is removed. Elastomeric materials are both stretchable and recoverable.

“Stretchable” and “recoverable” are descriptive terms used to describe the elastomeric properties of a material. “Stretchable” means that the material can be extended by a pulling force to a specified dimension significantly greater than its initial dimension without breaking. For example, a material that is 10 cm long that can be extended to about 13 cm long without breaking under a pulling force could be described as stretchable. “Recoverable” means that a material which is extended by a pulling force to a certain dimension significantly greater than its initial dimension without breaking will return to its initial dimension or a specified dimension that is adequately close to the initial dimension when the pulling force is released. For example, a material that is 10 cm long that can be extended to about 13 cm long without breaking under a pulling force, and which returns to about 10 cm long or to a specified length that is adequately close to 10 cm could be described as recoverable.

“Extensible” refers to polymer materials that can be stretched at least about 130% of their original dimension without breaking, but which either do not recover significantly or recover to greater than about 120% of their original dimension and therefore are not elastomeric as defined above. For example, an extensible film that is 10 cm long should stretch to at least about 13 cm under a stretching force, then either remain about 13 cm long or recover to a length more than about 12 cm when the stretching force is removed. Extensible materials are stretchable, but not recoverable.

“Plastoelastic” and “elastoplastic” as used herein are synonymous and refer to any material that has the ability to stretch in a substantially extensible or “plastic” manner during an initial stretch and relax cycle, yet which exhibits substantially elastic behavior and recovery during subsequent stretch and relax cycles. Plastoelastic materials contain at least one extensible component and at least one elastic component, which components can be in the form of polymeric fibers, polymeric layers, or polymeric mixtures.

“Activation” or “activating” refers to a process by which the elastomeric film or material is rendered easy to stretch. Most often, activation is a physical treatment, modification or deformation of the elastomeric film. Stretching a film for the first time is one means of activating the film. An elastomeric material that has undergone activation is called “activated.” A common example of activation is blowing up a balloon. The first time the balloon is inflated (or “activated”), the material in the balloon is stretched. If the inflated balloon is allowed to deflate and then blown up again, the “activated” balloon is much easier to inflate.

“High Speed Research Press” (HSRP) refers to a testing device that simulates activation by incremental stretching rolls. The HSRP is described in U.S. Pat. Nos. 6,843,134 and 7,062,983.

“Depth of Engagement” (DOE) is a measurement of the amount of overlap between the upper and lower intermeshing rolls during incremental stretching. DOE is measured vertically from the imaginary horizontal line running along the uppermost points of the tips of the intermeshing fins on the lower roll to the corresponding imaginary horizontal line running along the lowermost points of the tips of the intermeshing fins on the upper rolls.

“Permanent set” is the permanent deformation of the material after removal of an applied load. In the case of elastomeric films, permanent set is the increase in length of a sample of a film after the film has been stretched to a given length and then allowed to relax. Permanent set is typically expressed as a percent increase relative to the original size.

“Post activation set” is the permanent set of an elastic material which has undergone only the stretching associated with activation. The post activation set (PAS) of a material is measured by marking the material before activation with two pen marks separated by a known distance (L₁) in the direction of activation. The material is then activated, and the distance between the two marks is measured again (L₂). The post activation set, as a percent, is calculated by the equation:

PAS (%)=[(L₂−L₁)/L₁]×100

“Tear strength” is a property of a film or laminate which determines the ease or difficulty by which the film can be torn starting from a notch or aperture cut into the film, as measured by the notched Elmendorf test, ASTM D-1922.

“Pinholing” refers to the formation of small holes or tears in a film while the film is being formed, laminated, activated, or other manufacturing or processing step. “Pinholes” are the small holes or tears so formed. Pinholes are typically in the range of about 100 μm to 1 cm in size.

“Robust” refers generally to the tendency of a film, laminate, or other sheet-like material to remain intact and resist tearing, shredding, pinholing, or other forms of material failure while under applied stress or other physical manipulation. For example, a film which resists pinholing under a given stress is described as ‘more robust’ than another film which forms pinholes under equivalent stress.

The present invention provides laminates comprising bilaminates formed by extrusion or adhesive lamination. The inventors have discovered that varying the number and types of layers, for example, by sub-layering the films within the layers, or using an increased number of internal layers, can offer surprising property benefits. For instance, multilayer laminates of the present invention may exhibit improved toughness as demonstrated by improved pinhole resistance during activation.

A specific type of multilayer lamination, the dual bilaminate of the present invention, is designed by bringing together two bilaminate precursors, comprising a thin film layer laminated to a nonwoven layer, hence the term “dual bilaminates.” Current stretch laminates are typically constructed in separate steps by first extruding an elastic film, adhesively bonding it to two nonwovens, and taking the resulting laminate through an activation process. This generally places constraints on the film design, not only requiring the film to be thick enough to be stably extruded and wound by itself, but also in requiring coextruded inelastic skin layers or some type of surface treatment to prevent the sticky elastomeric film from blocking during production or after being wound into a roll. Also, nonwovens currently used in commercial applications are carded or spunbond fabrics that require large amounts of glue for the nonwoven to bond to the film and also prevent broken fibers from becoming loose and delaminating after activation.

The present invention offers an alternative approach to create multilayer laminates with a number of previously unsuspected benefits. These new dual bilaminates are designed to bring two thin bilaminate precursors together. Only a small amount of adhesive is necessary to bond the film surfaces of the two bilaminates, as films are inherently more readily bondable than nonwovens. Reducing the amount of adhesive used offers significant savings. Alternatively, the two bilaminate precursors can be combined by extruding a bonding layer of polymer between the film surfaces of the bilaminate precursors. Bilaminate precursors can also be combined by ultrasonic bonding, pressure bonding, thermal bonding, or hot pin aperturing, thereby avoiding the use of adhesive or additional polymer.

Each bilaminate precursor may have a total basis weight ranging from about 10 gsm to about 60 gsm, with the film ranging from about 5 gsm to about 30 gsm, and the nonwoven between about 5 gsm to about 60 gsm. The two bilaminate precursors are brought into contact and bonded on their film faces, and the total basis weight of the dual bilaminate will range from about 20 to about 120 gsm.

It has been unexpectedly found that two thin elastomeric bilaminate precursors can be bonded to form a robust dual bilaminate with better mechanical integrity than a trilaminate of equal basis weight made of two nonwoven layers and a single film that is twice as thick.

The dual bilaminates may be constructed with either the same bilaminate precursor, or two different bilaminate precursors made of different films or nonwovens. The bilaminates used are preferably the extrusion type, where process simplification and cost savings are derived both from the elimination of adhesive and the ability to use lower basis weight spunbond nonwovens. The bilaminate precursors may also be made by adhesive lamination. The dual bilaminates may have a more film layers than the previously disclosed trilaminate structures comprising nonwovens and either monolayer films or coextruded three layer films. For example, the dual bilaminates of the present invention may have combined multilayer films with four, six, eight, ten or more layers and one or more optional adhesive layers.

For other uses, two bilaminate precursors with different stretch and recovery properties may be combined to create new structures having unique gradient stretch profiles. For example, a strip of bilaminate precursor with a low permanent set (i.e. greater recovery after being stretched) may be bonded to a larger area of a base plastoelastic bilaminate precursor that exhibits a larger permanent set (i.e. less recovery after being stretched). When the combined laminate is subjected to mechanical activation, regions of gathered material are created within the base bilaminate precursor adjacent to the dual bilaminate strip, due to the differences in the permanent set of the bilaminate layers. Upon subsequent stretching, the dual bilaminate strip that includes the low permanent set bilaminate precursor will stretch significantly more than the base bilaminate precursor in its vicinity and will recover over the entire range. Then, after the first stretch, the strips made of the two bilaminate precursors will be the only area to stretch, up to the point where the adjacent plastoelastic bilaminate precursor begins to deform. The larger the plastic component in the plastoelastic bilaminate, the greater is the gathered appearance in the adjacent regions and the larger the strain required to deform the plastoelastic bilaminate precursor. The ultimate amount of gathering may be achieved with a fully plastic film replacing a plastoelastic one, but the trade-off is a lower residual elasticity in laminates with a greater plastic component. The gathered effect may be greater if the low permanent set bilaminate precursor is actually pre-strained and held under tension prior to being adhesively bonded to the base bilaminate.

The elastomeric polymers used in the thin polymer film layer of this invention may comprise any extrudable elastomeric polymer resin. Examples of such elastomeric polymer resins include block copolymers of vinyl arylene and conjugated diene monomers, natural rubbers, polyurethane rubbers, polyester rubbers, elastomeric polyolefins and polyolefin blends, elastomeric polyamides, or the like. The elastomeric film may also comprise a blend of two or more elastomeric polymers of the types previously described.

For instance, one useful group of elastomeric polymers are the block copolymers of vinyl arylene and conjugated diene monomers, such as AB, ABA, ABC, or ABCA block copolymers where the A segments comprise arylenes such as polystyrene and the B and C segments comprise dienes such as butadiene or isoprene. A similar group of elastomeric polymers are the block copolymers of vinyl arylene and hydrogenated olefin monomers, such as AB, ABA, ABC, or ABCA block copolymers where the A segments comprise arylenes such as polystyrene and the B and C segments comprise saturated olefins such as ethylene, propylene, or butylene. Examples of such elastomeric polymers, known generically as styrene block copolymers (SBCs), include such polymers as styrene-butadiene-styrene (SBS), styrene-isoprene-styrene (SIS), styrene-ethylenebutylene-styrene (SEBS), styrene-ethylene-propylene (SEP), styrene-ethylene-propylene-styrene (SEPS), or styrene-ethylene-ethylene-propylene-styrene (SEEPS) block copolymer elastomers, or blends thereof. It is well known the SBC elastomers exhibit superior elastomeric properties. Suitable SBC resins are readily available from: KRATON® Polymers of Houston, Tex.; Dexco™ Polymers LP of Planquemine, LA; or Septon™ Company of America of Pasadena, Tex.

The use of SBC elastomers in an elastomeric film yields a film that has excellent stretch and recovery characteristics. However, as discussed previously, unsaturated SBC elastomers are prone to thermal degradation when they are overheated, and saturated SBC's tend to be very expensive. In addition, SBC's can be difficult to process and extrude into films, especially thin films of the present invention.

Another useful group of elastomeric polymers are olefin-based elastomers. In a preferred embodiment, the elastomeric film comprises a polyolefinic elastomer (POE). One example of POEs include olefin block copolymers (OBCs) which are elastomeric copolymers of polyethylene, sold under the trade name INFUSE™ by The Dow Chemical Company of Midland, Mich. Other examples of POEs are copolymers of polypropylene and polyethylene, sold under the trade name VISTAMAXX® by ExxonMobil Chemical Company of Houston, Tex.

These POEs exhibit greater heat stability than unsaturated SBC elastomers, so a film comprising POEs can be extruded at higher temperatures and lower viscosity. POEs have processability characteristics more like standard nonelastomeric polyolefins, and therefore they are easier to extrude as thin films. Finally, the POEs are chemically similar to the polyolefins used for nonwovens. This chemical similarity improves the chemical affinity between the film layer and nonwoven layer(s) in the laminate. Hence the laminate has an improved bond strength due to chemical adhesion in addition to mechanical bonding.

For the elastomeric film, other polymers may be blended into the compositions to enhance desired properties. For example, a linear low-density polyethylene may be added to the film composition to lower the viscosity of the polymer melt and enhance the processability of the extruded film. High-density polyethylene may be added to prevent age-related degradation of the other polymers. High impact polystyrene (HIPS) has been found to control the film modulus, improve the toughness of the film, and reduce the overall cost of the elastomeric material. Polypropylene has been found to improve the robustness of the elastomer and improve the films' resistance to pinholing and tearing.

The elastomeric films of the present invention may optionally comprise other components to modify the film properties, aid in the processing of the film, or modify the appearance of the film. Viscosity-reducing polymers and plasticizers may be added as processing aids. Antiblocking agents may be added to the film to prevent blocking during manufacture or storage. Other additives such as pigments, dyes, antioxidants, antistatic agents, slip agents, foaming agents, heat or light stabilizers, UV stabilizers, and inorganic or organic fillers may be added. In multilayer films, these additives may optionally be present in one, several, or all layers of the film.

In a preferred embodiment, the inventive elastomeric film may comprise a multilayer film. In a more preferred embodiment, the inventive elastomeric film may comprise a coextruded multilayer film with an ABA-type, an ABCBA-type, or an ABCA-type construction. In this case, the A layers comprise the same composition, and form the outer layers of the film, which are also called the ‘skin,’ ‘surface,’ or ‘tie’ layers. The B layer(s), which forms the so-called ‘core’ or ‘inner’ layer, may be the same composition as the A layers, or the B layer may comprise a composition other than the A layers. The C layer(s), which forms one or more additional polymeric layers that are with the inner layers, may be identical to the A layers or the B layer(s), or the C layer(s) may comprise a composition other than the A or B layers. Each layer of a multilayer elastomeric film may comprise elastomeric polymers, or the layers may comprise either elastomeric, plastoelastic, or plastic non-elastomeric polymers, either singly or in combination, in each layer. The only limitations are that at least one layer of the multilayer elastomeric film must comprise an elastomeric polymer and the multilayer elastomeric film as a whole must be an elastomeric film.

For the A layers of the multilayer film of ABA, ABCBA, or other multilayer construction, these A layers may comprise a polyolefin polymer. The A layers may also comprise an elastomeric polymer. For the A layers, the use of polyolefin-based elastomers may be desired. It has been discovered that A layers containing POE's improve the processability of the elastomeric film, as discussed above, even when the core layer is an SBC or other less processable polymer. POE's on the surface of the film may have a greater chemical affinity for a polyolefinic nonwoven joined to the surface of the film in the laminate. This greater chemical affinity may improve the laminate strength between the film surface and a nonwoven layer.

For the B, or core, layer(s) of the ABA, ABCBA, or other multilayer elastomeric film, the core may comprise any elastomeric polymer. In one embodiment, the core layer(s) may be an SBC, such as SBS, SIS, SEBS, SEP, SEPS, or SEEPS block copolymer elastomers, or blends thereof. In another embodiment, the inner B layer(s) of the multilayer film may be a thermoplastic polyolefin, such as the POE's mentioned above, including OBC's such as Infuse™ and PP/PE copolymers such as Vistamaxx®, and combinations thereof. In another embodiment, the inner B layer(s) of the multilayer film may comprise a blend of SBC and a POE. In another embodiment, the inner B layer(s) of the multilayer film may comprise a blend of SBC and a plastoelastic polymer. In another embodiment, the inner B layer(s) of the multilayer film may comprise a blend of SBC and a plastic polymer.

In the present invention, homopolymer polypropylene (hPP) may be blended into one or more of the inner layers B or into an additional polymeric layer C to improve processability. hPP is a form of polypropylene which is highly crystalline and contains essentially 100% propylene monomer. It has been found that SBC-based elastomeric films with hPP can be extruded at a thinner gauge and with improved gauge uniformity, and the addition of hPP may reduce the tendency of the film to experience draw resonance during extrusion.

Any film-forming process can prepare the elastomeric film. Preferably, an extrusion process, such as cast extrusion or blown-film extrusion forms the film. Such processes are well known. If the elastomeric film is a multilayer film, the film can be formed by a coextrusion process. Coextrusion of multilayer films by cast or blown processes are also well known.

In order to manufacture a thin-gauge elastomeric film, the average basis weight of the elastomeric film must be controlled. If a polymer is hard to process, then the extruded film of that polymer will be hard to control. This lack of control is seen in problems like fluctuating basis weights, draw resonance, web tear-offs, and other significant problems. As discussed above, SBC elastomers tend to have relatively poor processability, and hence it is very hard to manufacture a film with a controlled basis weight. These problems are only magnified as one attempts to manufacture films with lower basis weights.

However, by extruding films comprising POE polymers or, alternatively, POE polymer skins, the processability of the elastomeric film is improved, and the problems associated with basis weight control are reduced or eliminated. The inventors have discovered that thin-gauge films are much easier to manufacture, even with high concentrations of SBCs in the core layer, when POE polymers comprise the film skin layers.

Another problem with manufacturing lower basis-weight films is their reduced mass, which causes the extruded polymer web to solidify more rapidly. If the extruded polymer web solidifies too quickly, then the polymer film is ‘locked’ into the thickness that exists at that time. This situation is directly comparable to the ‘frost line’ experienced in blown film technology. Once the film has solidified, it cannot be easily drawn to a thinner gauge. Rapid cooling due to lower mass is particularly a problem with elastomers like unsaturated SBCs, which are prone to thermal degradation when heated to excessively high temperatures. Simply heating the unsaturated SBC to a higher temperature to compensate for the reduced mass of the extruded web is not feasible.

On the other hand, POE elastomeric polymers are more thermally stable than SBC elastomers, and thus can be heated to a higher temperature. This increases the total heat present in the extruded polymer web, so the web must release more heat before solidifying. POE's also solidify at lower temperatures than do SBC's, so there is a greater differential between the temperature of the extruded polymer and the temperature at which the film solidifies. The inventors have also discovered, unexpectedly, that coextruding an SBC-based core within POE-based skin layers both allows the coextruded multilayer film to be extruded at a higher overall temperature, thereby compensating somewhat for the reduced-mass heat loss, and also increasing the time it takes for the extruded molten web to solidify. This allows the manufacturer to extrude the multilayer elastomeric polymer web and draw the web to a lower basis weight before the web solidifies.

It may be desirable for certain aspects of the present invention to use an elastic film that is less than about 65 gsm, or less than about 40 gsm, or less than about 30 gsm, or less than about 20 gsm, or less than about 15 gsm, or less than about 10 gsm, but greater than about 1 gsm or about 5 gsm. Elastic films of the present invention may have a thickness or caliper (also known as z-direction thickness) in the range of about 1 μm to about 65 μm, or from about 1 μm to about 40 μm, or from about 1 μm to about 30 μm, or from about 1 μm to about 20 μm, or from about 1 μm to about 15 μm, or from about 1 μm to about 10 μm.

In one embodiment of the present invention, an elastic bilaminate precursor is formed by extrusion lamination of the elastomeric film onto a substrate layer such as a nonwoven fabric. In another embodiment, the elastic bilaminate precursor is formed by adhesive lamination of the elastomeric film onto a substrate layer such as a nonwoven fabric.

The nonwovens typically used to make the elastomeric laminate of the present invention are generally formed from fibers which are interlaid in a random fashion. Examples of suitable nonwoven fabrics include spunbond, carded, meltblown, and spunlaced nonwoven webs. In some embodiments, the nonwoven may include multiple layers of fibers. For instance, a nonwoven may comprise a single layer of spunbond fibers (S) or multiple layers of spunbond fibers (SSS). In other embodiments, the nonwoven may comprise layers of fibers that differ in diameter or composition, such as spunbond-meltblown-spunbond (SMS) nonwovens. Other multilayer nonwovens, such as SMMS, SSMMS, etc. may be used.

These fabrics may comprise fibers of polyolefins such as polypropylene or polyethylene, polyesters, polyamides, polyurethanes, elastomers, rayon, cellulose, copolymers thereof, or blends thereof or mixtures thereof. The nonwoven fabrics may also comprise fibers that are homogenous structures or comprise bicomponent structures such as sheath/core, side-by-side, islands-in-the-sea, segmented pie, and other known bicomponent configurations. For a detailed description of nonwovens, see “Nonwoven Fabric Primer and Reference Sampler” by E. A. Vaughn, Association of the Nonwoven Fabrics Industry, 3d Edition (1992). A preferred nonwoven comprises bicomponent fibers of sheath-core construction, where the fiber sheath comprises polyethylene and the fiber core comprises polypropylene. Another preferred nonwoven comprises bicomponent fibers of sheath-core construction, where the fiber sheath comprises polyethylene and the fiber core comprises polyethylene terephthalate ester (PET).

Such nonwoven fabrics typically have a weight of about 5 grams per square meter (gsm) to 75 gsm. In a preferred embodiment, the nonwoven fabric should have a basis weight of less than about 30 gsm, about 25 gsm, about 20 gsm, about 15 gsm, or about 10 gsm, in keeping with the thin gauge of the elastomeric film. The nonwoven fabrics may also comprise fibers of all shapes. The inventors have found that nonwoven fabrics with “flat” fibers, such as fibers that are rectangular or oblong in cross section, tend to bond better to the elastomeric film than nonwoven fabrics with fibers that are circular in cross section. Alternatively, notched fibers, such as trilobal or multilobal fibers, may be used.

Controlling the bond strength between the elastomeric film and the fabric layers of the inventive elastomeric laminate is an important aspect of the present invention. If the film and nonwoven are bonded poorly, the layers may delaminate during activation or later use. If the layers are bonded too tightly, however, the tight bond can cause pinholes to form in the film during activation. Bond strength is typically measured by a method such as ASTM D-1876.

Bond strength between the layers can be controlled by a number of ways, depending on the lamination method. If the layers are laminated by an adhesive method, the choice of adhesive and the amount of adhesive applied to bond the layers can be adjusted to achieve the desired bond strength. In one example, the adhesive may be H2861 or 2511, which are available from Bostik Inc. of Wauwatosa, Wis., or 3M super77 spray adhesive, which is available from 3M of St. Paul, Minn.

If the layers are laminated by an extrusion lamination process, however, the temperature of the extruded molten elastomeric web may become problematic. Because the extruded polymer film of the present invention is of thin gauge, the extruded web has less mass to retain heat during the extrusion process. Less mass means that the extruded molten polymer web tends to solidify very rapidly. As discussed previously, this rapid solidification creates problems when trying to manufacture thinner films. Additionally, if the extruded polymer film solidifies too rapidly, it is harder to achieve adequate bond strength between the extruded elastomeric film and any fabric layers in an extrusion laminate. This is particularly a problem when the extruded polymer does not have great chemical affinity for the materials that comprise the fabric. SBC elastomers do not have strong natural chemical affinity for the polyolefinic materials typically used for nonwoven fabrics. In order to achieve adequate bond, laminates of SBC elastomers and nonwoven fabrics must rely on mechanical bonding forces, such as those achieved by embedding the fabric fibers into the surface of the film. Unfortunately, if the film has solidified before contacting the nonwoven, the fabric fibers cannot be embedded into the solidified surface of the film. Hence, the bond strength between the layers of the laminate is poor, and the elastomeric material will tend to delaminate easily.

Because the thin POE-based films can be heated to higher temperatures and do not solidify as rapidly as the SBC-based materials, the extruded elastomeric web may be still semi-molten and soft when it contacts the nonwoven fibers, which allows the fibers to embed into the surface. This creates a good mechanical bond between the film and nonwoven. POE elastomers also have more chemical affinity than SBC's for the polyolefinic materials in nonwoven fabrics, because the POE's are themselves polyolefinic materials. The chemical affinity of POE's for nonwoven materials means that these layers are more apt to bond even with little mechanical bonding from embedded nonwoven fibers. For this reason, skin layers comprising POE elastomers make excellent tie layers that enhance the bond between the extruded film and nonwoven fabric.

In particular, tie layers containing copolymers of ethylene and propylene, or blends of ethylene- and propylene-based polymers, can be fine-tuned to provide optimal chemical affinity and bond strength with the nonwoven. For example, in a laminate comprising a bicomponent nonwoven with a polyethylene sheath, a tie layer containing polyethylene homopolymer may have too much chemical affinity and therefore bond too tightly to the nonwoven, whereas a tie layer containing polypropylene homopolymer may have too little chemical affinity and bond poorly. A tie layer comprising an ethylene-propylene copolymer with about 10-97% ethylene content may provide a balanced chemical affinity for optimal bonding between the film and nonwoven—neither too tight a bond that causes pinholes, nor too loose a bond that allows delamination.

Hence, the inventors have observed that POE-based elastomeric films, or alternatively multilayer elastomeric films with POE-based tie layers, form laminates with better-controlled bond strength and less tendency to delaminate from nonwovens comprising polyolefins such as polypropylene, or bicomponent nonwovens comprising a polyolefin sheath such as polyethylene.

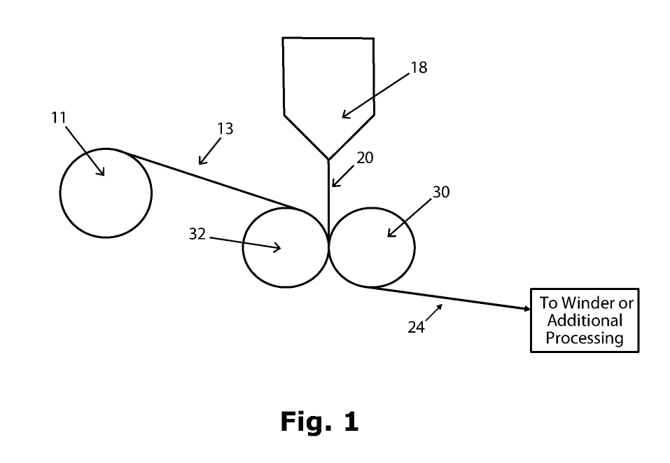

FIG. 1 illustrates a schematic for a typical cast extrusion lamination process. This process can be used to form the bilaminate precursor that is used in the present invention. A polymer composition for the elastomeric film is melted in a conventional screw extruder and extruded from the extrusion die 18 to form a molten polymer web 20. The molten polymer web 20 is extruded into the nip between the illustrated metal roll 30 and backing roll 32. The metal roll may be chilled to rapidly cool the molten polymer film. The metal roll 30 may also be engraved with an embossing pattern if such a pattern is desired on the resulting film. The fabric layer 13 of the elastomeric laminate is unwound from roll 11 and introduced into the nip between the metal and rubber rolls as well. The extruded film layer 20 and fabric layer 13 are pressed together at the nip to bond the layers. The elastomeric bilaminate precursor 24 may now be wound into a roll or go on for further processing.

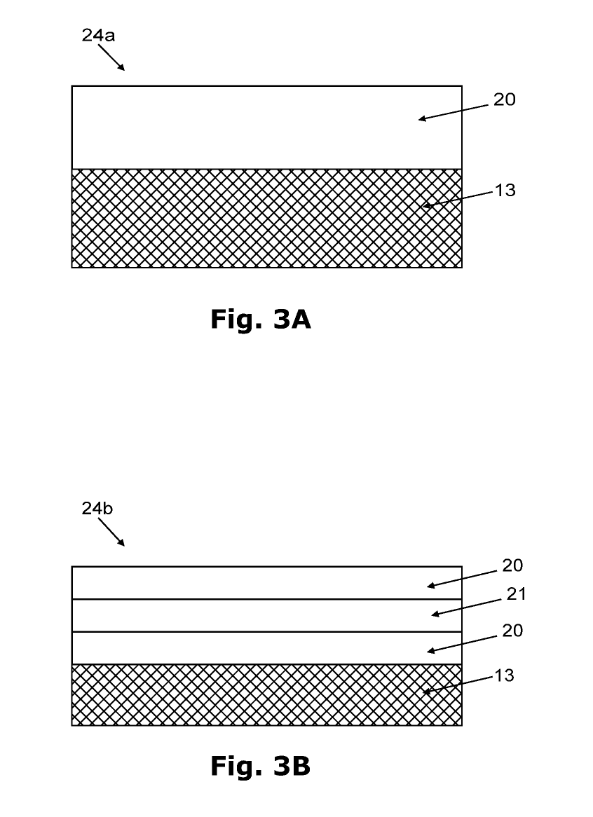

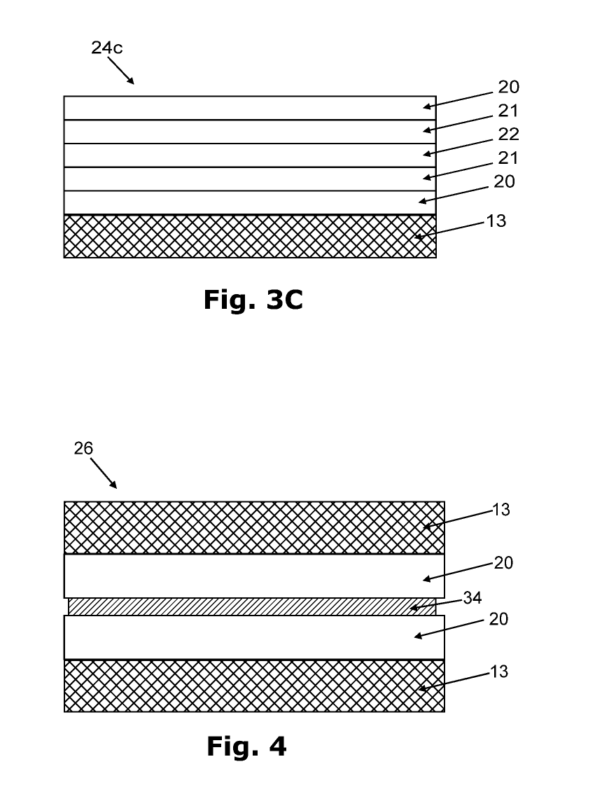

FIGS. 3a-3c illustrate several embodiments of bilaminate precursors generated in the extrusion lamination step. FIG. 3a illustrates a bilaminate precursor 24a comprising a monolayer elastomeric film layer 20 which is bonded coextensively to the fabric layer 13. FIG. 3b illustrates a bilaminate precursor 24b comprising a multilayer ABA elastomeric film with outer A layers 20 and core B layer 21, which is bonded coextensively to the fabric layer 13. FIG. 3c illustrates a bilaminate precursor 24c comprising a multilayer ABCBA elastomeric film with outer A layers 20, inner B layers 21, and core layer C 22, which is bonded coextensively to the fabric layer 13.

Once the elastomeric bilaminate precursor is formed, it is bonded to another bilaminate precursor to form the inventive elastomeric laminate. The bilaminate precursors are bonded film-to-film, resulting in a central multilayer film laminated to outer layers of nonwoven. There are many known bonding methods that may be used to bond the elastomeric bilaminate precursors to one another. Such methods include adhesive bonding, extrusion bonding, thermal bonding, ultrasonic bonding, calender bonding, point bonding, and laser bonding. Combinations of bonding methods are also within the scope of the present invention.

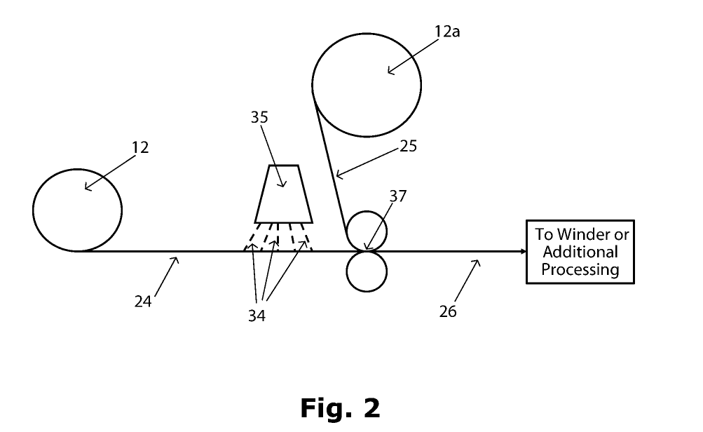

The preferred method of bonding the bilaminate precursor layers is adhesive lamination, illustrated in FIG. 2. A first bilaminate precursor 24 is transported from roll 12 (or the extruder) to an adhesive bonding station, where adhesive 34 is applied by means such as a spray unit 35 onto the film surface of the bilaminate precursor 24. Alternatively, the spray unit 35 may spray adhesive onto the free film surface of the incoming second bilaminate precursor 25. The second bilaminate precursor 25 is unwound from roll 12a and introduced into a nip 37 that presses the first elastomeric bilaminate precursor 24 and the second bilaminate precursor 25 to bond the layers. The elastomeric laminate 26 may now be wound into a roll or go on for further processing.

FIG. 4 shows one embodiment of the elastomeric laminate 26 of the present invention. Here, two identical bilaminate precursors (each bilaminate precursor comprising a nonwoven layer 13 and a monolayer film 20) are bonded together with a layer of adhesive 34. The bilaminate precursors are bonded with the adhesive between the film surfaces of each bilaminate. Hence, the final laminate structure is nonwoven 13/film 20/adhesive 34/film 20/nonwoven 13.

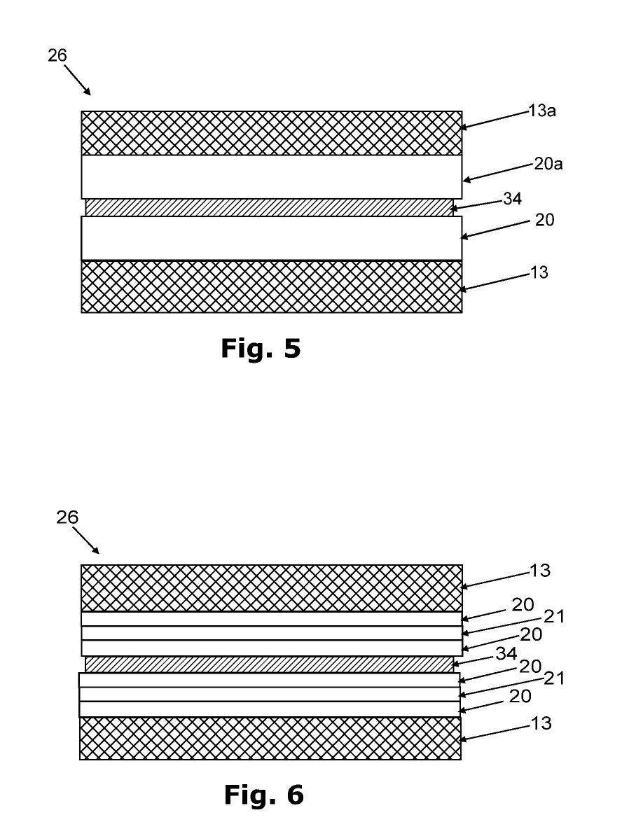

FIG. 5 shows another embodiment of the elastomeric laminate 26 of the present invention. Here, two different bilaminate precursors are bonded together with a layer of adhesive 34. In this embodiment, the top bilaminate precursor comprises a film 20a which differs from the bottom bilaminate precursor film 20. Similarly, the nonwoven layer 13a of the top bilaminate precursor differs from the nonwoven layer 13 of the bottom bilaminate precursor. The bilaminate precursors are bonded with the adhesive between the film surfaces of each bilaminate. Hence, the final laminate structure is nonwoven 13/film 20/adhesive 34/film 20a/nonwoven 13a.

FIG. 6 shows another embodiment of the elastomeric laminate 26 of the present invention. Here, two multilayer bilaminate precursors are bonded together with a layer of adhesive 34. In this embodiment, each bilaminate precursor comprises a three-layer film with outer layers 20 and an inner layer 21, said three-layer film being bonded to a nonwoven fabric 13. The bilaminate precursors are bonded with the adhesive between the film surfaces of each bilaminate. Hence, the final laminate structure is nonwoven 13/multilayer film 20/21/20/adhesive 34/multilayer film 20/21/20/nonwoven 13. In this embodiment, the bilaminate precursors may comprise the same or different nonwovens or film layers.

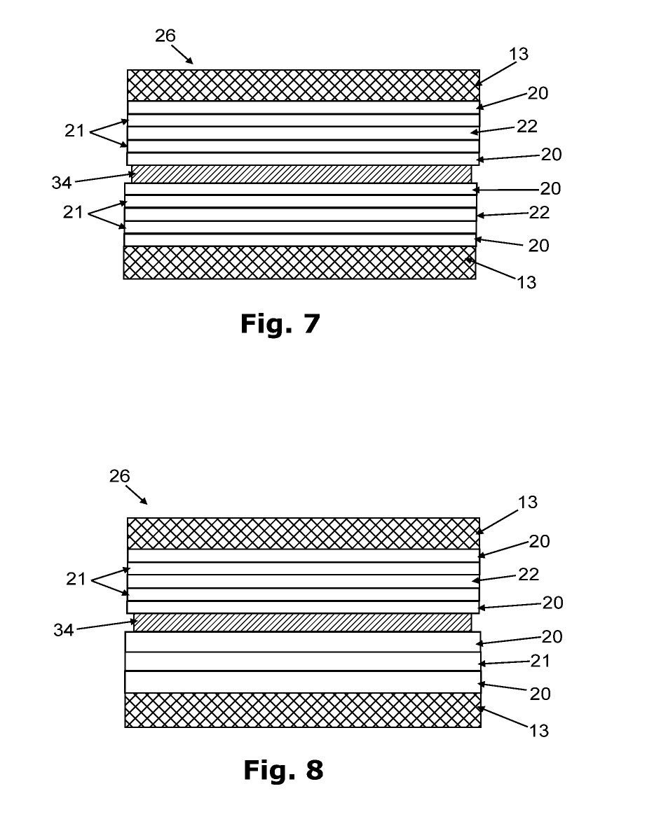

FIG. 7 shows another embodiment of the elastomeric laminate 26 of the present invention. Here, two multilayer bilaminate precursors are bonded together with a layer of adhesive 34. In this embodiment, each bilaminate precursor comprises a five-layer film with outer layers 20, intermediate layers 21, and an inner layer 22, said five-layer film being bonded to a nonwoven fabric 13. The bilaminate precursors are bonded with the adhesive between the film surfaces of each bilaminate. Hence, the final laminate structure is nonwoven 13/multilayer film 20/21/22/21/20/adhesive 34/multilayer film 20/21/22/21/20/nonwoven 13. In this embodiment, the bilaminate precursors may comprise the same or different nonwovens or film layers.

FIG. 8 shows another embodiment of the elastomeric laminate 26 of the present invention. Here, two multilayer bilaminate precursors are bonded together with a layer of adhesive 34. In this embodiment, the top bilaminate precursor comprises a five-layer film with outer layers 20, intermediate layers 21, and an inner layer 22, and the bottom bilaminate precursor comprises a three-layer film with outer layers 20 and an inner layer 21 (each film being bonded to nonwovens 13). The bilaminate precursors are bonded with the adhesive between the film surfaces of each bilaminate. Hence, the final laminate structure is nonwoven 13/multilayer film 20/21/22/21/20/adhesive 34/multilayer film 20/21/20/nonwoven 13. In this embodiment, the bilaminate precursors may comprise the same or different nonwovens or film layers.

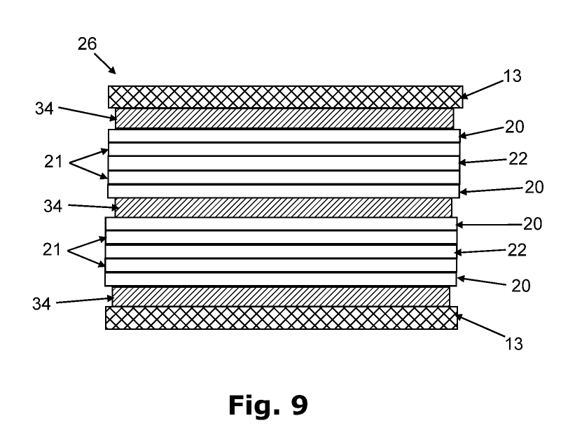

FIG. 9 shows another embodiment of the elastomeric laminate 26 of the present invention. Here, two multilayer bilaminate precursors are bonded together with layers of adhesive 34. In this embodiment, each bilaminate precursor comprises a five-layer film with outer layers 20, intermediate layers 21, and an inner layer 22, said five-layer film being adhesively bonded to a nonwoven fabric 13 with a layer of adhesive 34. The bilaminate precursors are then bonded with another layer of adhesive 34 between the film surfaces of each bilaminate. Hence, the final laminate structure is nonwoven 13/adhesive 34/multilayer film 20/21/22/21/20/adhesive 34/multilayer film 20/21/22/21/20/adhesive 34/nonwoven 13. In this embodiment, the bilaminate precursors may comprise the same or different nonwovens or film layers, and the adhesives used between the layers may be the same or different.

It is to be understood that additional processing steps such as activating the elastomeric laminate, aperturing the laminate, printing the laminate, slitting the laminate, laminating additional layers to the laminate, and other such processes may be added to the inventive process and are within the scope of this invention.

For example, the elastomeric film may be activated by known stretching means. Laminates of elastomeric films and fabrics are particularly suited to activation by incremental stretching. As disclosed in the commonly-assigned U.S. Pat. No. 5,422,172 (“Wu '172”), which is incorporated by reference, elastomeric laminates of the sort made here can be activated by incremental stretching using the incremental stretching rollers described therein. Incremental stretching rollers can be used to activate films in the machine direction, cross direction, at an angle, or any combination thereof.

It is known in film technology that one way to avoid pinholes in stretched materials is to bond two separately stretched layers together. If the individually stretched layers develop pinholes, it is unlikely that pinholes in both layers will align to create a hole that goes through both layers. For instance, in microporous breathable film technology, the stretching that creates micropores in the film can also generate pinholes that can allow liquids to leak through the film. By bonding two layers of microporous film together coextensively, however, there is very little chance that a pinhole in each layer will occur in the same area of the bonded double-layer film. Hence, there is little chance that such a bonded double-layer film will leak. This is not because there are no pinholes, though; instead, it is because existing pinholes do not align in the final bonded film.

However, it was unexpectedly discovered that elastomeric laminates created by laminating two bilaminate precursor layers together are particularly resistant to activation pinholes. When the bilaminate precursor layers of the present invention were carefully separated after activation, it was found that no pinholes were generated, despite there being very thin films in the bilaminate precursors. In other words, an elastomeric laminate created from bonding two very thin bilaminate precursors had essentially no activation pinholes created during activation, unlike previously known stretched films and laminates where the pinholes existed but simply did not align in the final bonded double layer product.

Because they resist pinholing and therefore show improved puncture resistance during activation, the dual bilaminates have other unexpected benefits. The dual bilaminates of the present invention can be activated by deeper depth of engagements (DOEs) and therefore achieve higher stretch. Alternatively the film components of the dual bilaminates can be down-gauged to achieve cost savings. Another benefit is that with more and/or thicker plastic layers in the film, the plastoelastic response of the film to mechanical activation can be tailored. Another benefit is that dual bilaminates can improve the film processability, with higher line speeds, and lower film basis weights. Because the nonwoven acts as a carrier web for the process, extrusion lamination enables the production of bilaminates with very low film basis weights. The nonwoven can also prevent film blocking in the resulting bilaminate, which reduces or eliminates the need for antiblocking additives or manufacturing techniques to prevent blocking.

Another benefit of the present invention is that it may be possible that the trimmed edges of the laminate or other waste laminate material can be recycled into an additional polymeric layer (for example, the C layer) within the multilayer film structure, without detrimental change in the properties. Alternatively, one could incorporate a lower cost filled layer to reduce the overall cost of the film. A combination of filled and unfilled layers may produce micropores across the thickness of the film and thus introduce breathability.

Without being bound by theory, it is believed that the presence of the central adhesive layer provides some “give” to the laminate, allowing the film layers to flex slightly during activation, which reduces the likelihood of pinhole formation. It is also believed that, for the embodiments incorporating multilayer films, the core film layers reduce the risk of pinholes forming during activation. Using stress diffusive sublayers made of flexible, ductile, and energy absorbing material is thought to improve the overall mechanical integrity of the laminate. Film tearing may also be prevented by the presence of nonwovens that are closely bonded to the film because the nonwovens may stop the progress of a tear in the film.

The following examples are presented to illustrate embodiments of the present invention. These examples are not intended to limit the invention in any way.

### Example 1

An elastomeric laminate of the present invention was prepared and tested for robustness. A bilaminate precursor was made by extrusion lamination. The film component of the bilaminate precursor comprised a monolayer elastomeric film comprising approximately 80% Vistamaxx®POE, from ExxonMobil Chemical, 15% Elite™ linear low density polyethylene, from The Dow Chemical Company, and 5% white masterbatch concentrate from Schulman Corporation. This elastomeric film was extruded at 10 gsm basis weight and laminated to a 15 gsm bicomponent spunbond nonwoven on a cast-extrusion line. Two layers of the bilaminate precursor were then adhesively bonded such that the free film surfaces of the bilaminate precursors were facing each other. The laminate was then activated by incremental stretching at a DOE of 0.160 inches.

### Example 2

A portion of the activated laminate of Example 1 was soaked in acetone to dissolve the adhesive layer. The activated bilaminate precursors which made up this portion of the inventive laminate were then carefully separated for further testing.

### Comparative Example 1

A standard elastomeric laminate was prepared and tested for robustness. The film component of the laminate comprised a monolayer elastomeric film comprising approximately 80% Vistamaxx®POE, from ExxonMobil Chemical, 15% Elite™ linear low density polyethylene, from The Dow Chemical Company, and 5% white masterbatch concentrate from Schulman Corporation. This elastomeric film was extruded at 20 gsm basis weight and laminated between two layers of 15 gsm bicomponent spunbond nonwoven on a cast-extrusion line. The comparative laminate was then activated by incremental stretching at a DOE of 0.160 inches.

The laminates made in Example 1, Example 2, and Comparative Example 1 were tested for pinholes using the “Pinhole Testing—Dye” method described below. Using this method, the inventive laminate Example 1 did not show the presence of pinholes. Neither did either activated bilaminate precursor from Example 2. This shows that the bilaminate precursors resist forming pinholes during activation, unlike known stretched double-layer materials that merely mask activation pinholes because the pinholes do not align in the final product. In contrast, the Comparative Example was found to contain many activation pinholes, which allowed the red dye to penetrate the laminate and stain the paper toweling beneath.

### Example 3

An example of a dual bilaminate was prepared by first extrusion laminating an ABA multilayer film onto one layer of a nonwoven, resulting in a structure NW/A/B/A. The A layers of the film comprised a blend of about 25% Infuse 9107 POE (Dow Chemical Company), about 75% Elite 5800 polyethylene (Dow), and about 1% Ampacet 10562 process aid (Ampacet Corporation) (the “Infuse/PE blend”). The B layer of the film comprised a blend of about 87% Vistamaxx 6102 POE (ExxonMobil Company), about 5% INSPIRE 118 polypropylene (Dow), about 7% Ampacet 110361 white masterbatch (Ampacet) and about 1% Ampacet 10562 process aid (the “VM blend 1”). The nonwoven used was a 15 gsm sheath/core bico nonwoven, comprising fibers that comprise about 50% by weight of a polyethylene sheath and 50% by weight of a polypropylene core (Pegas Nonwovens, Czech Republic) (“Nonwoven 1”). The laminate Example 3A was manufactured with a total film basis weight of 10 gsm. Two layers of the laminate 3A were then adhesively laminated together on the film faces with about 4.5 gsm of Bostik H2861 adhesive (“adh”). This created a dual bilaminate 3B with the structure NW/A/B/A/adh/A/B/A/NW. The dual bilaminate structure 3B had a total NW basis weight of 30 gsm, a total film basis weight of 20 gsm, and a total adhesive basis weight of 4.5 gsm.

### Comparative Example 2

A comparative example of a trilaminate was prepared by extrusion laminating an ABA multilayer film onto one layer of nonwoven, resulting in a structure NW/A/B/A. The A layers of the film comprised the Infuse/PE blend. The B layer of the film comprised the VM blend 1. The nonwoven used was the Nonwoven 1. The comparative example was manufactured with a total film basis weight of 20 gsm. This laminate was then adhesively laminated to another layer of Nonwoven 1 on the film face with about 4.5 gsm of Bostik H2861 adhesive. This created a trilaminate with the structure NW/A/B/A/adh/NW. The trilaminate structure had a total NW basis weight of 30 gsm, a total film basis weight of 20 gsm, and a total adhesive basis weight of 4.5 gsm.

Both Example 3B and Comparative Example 2 were then activated at two DOEs: 0.160″ and 0.180″. The properties of the activated laminates are given below in Table 1.

TABLE 1

| | Example | | | |
|---|---|---|---|---|
| | Example 3B | | Comp. Example 2 | |
| Depth of Engagement (DOE) | 0.160″ | 0.180″ | 0.160″ | 0.180″ |

Tensile Test Results

| | | | | |
|---|---|---|---|---|
| Stretch at 1 N/cm | 116 | 144 | 115 | 141 |
| (% engineering strain) | | | | |
| Ultimate Tensile Strength (N/cm) | 2.7 | 2.4 | 3.1 | 2.8 |
| Strain at Break | 594 | 567 | 439 | 375 |
| (% engineering strain) | | | | |
| Range of Strain at Break | 539-627 | 482-608 | 284-627 | 282-552 |
| (% min-max) | | | | |
| % RSD for Strain At Break | 30 | 43 | 115 | 98 |

Pin Hole Evaluation - Visual Method (holes/m2)

| | | | | |
|---|---|---|---|---|
| Small (>0.5 to 1.0 mm) | 0 | 28 | 24 | 421 |
| Medium (>1.0 to 2.0 mm) | 0 | 0 | 4 | 31 |
| Large (>2.0 to 3.0 mm) | 0 | 0 | 0 | 0 |
| Extra large (>3.0 mm) | 0 | 0 | 0 | 0 |

In the case of the dual bilaminate 3B, the Strain at Break is roughly the same at both DOE levels, and the Strain at Break is fairly consistent over a number of samples. For the trilaminate Comparative Example 2, the average Strain at Break at each DOE is lower than for the comparable 3B samples, and the measured Strain at Break has much greater variability over a number of samples. In addition, the dual bilaminate 3B has significantly fewer pinholes at both DOE levels compared to Comparative Sample 2. These results support the theory that laminates with more layers have improved toughness and better consistency in tensile properties. Without being bound by theory, the inventors think that the inventive dual bilaminates have more consistent tensile properties because the dual bilaminates resist the formation of pinholes. The comparative example is more likely to form pinholes during manufacture. If pinholes do not form, the comparative example has good tensile properties such as strain at break. If the comparative example has pinholes, however, the pinhole can cause the film to tear easily at a much lower strain, and the laminate breaks prematurely. Thus, the comparative example has tensile properties that are much less consistent than the inventive example. Because of this inconsistency, laminates like the comparative example must have films that are thicker and more robust to prevent pinholes from forming; in other words, the comparative laminate films must be over-engineered to reduce the chance of pinholes and, therefore, premature failure. On the other hand, if the manufacturer can rely on the laminate film to resist pinhole formation, then the manufacturer can make the laminate film just thick and robust enough to meet the other technical requirements of the material. Hence, by incorporating dual bilaminate materials of the present invention, a manufacturer can make a thinner, less expensive laminate with more consistent tensile properties, and rely on the dual bilaminate to not fail at low strains.

### Example 4

An example of a dual bilaminate was prepared by first extrusion laminating an ABA multilayer film onto one layer of a nonwoven, resulting in a structure NW/A/B/A. The A layers of the film comprised the Infuse/PE blend described in Example 3. The B layer of the film comprised a blend of about 92% Vistamaxx 6102 (ExxonMobil Company), about 7% Ampacet 110361 white masterbatch (Ampacet Corp) and about 1% Ampacet 10562 process aid (the “VM blend 2”). The nonwoven used was the Nonwoven 1. The laminate Example 4A was manufactured with a total film basis weight of about 15 gsm. Two layers of the laminate 4A were then adhesively laminated together on the film faces with about 6 gsm of Bostik H2861 adhesive. This created a dual bilaminate 4B with the structure NW/A/B/A/adh/A/B/A/NW. The dual bilaminate structure 4B had a total NW basis weight of 30 gsm, a total film basis weight of 30 gsm, and a total adhesive basis weight of 6 gsm. The dual bilaminate 4B was then activated on the HSRP at a DOE of 0.250″.

### Example 5

A five layer film was prepared by coextrusion, resulting in a structure A/B/C/B/A. The A film layer was the Infuse/PE blend described in Example 3. The B layer comprised Vistamaxx 6102. The C layer comprised trim materials that would have otherwise been discarded, thus comprising Vistamaxx 6102, Infuse 9107, and Elite 5800 blended with PP3155 polypropylene (ExxonMobil Chemical Company) and Aspun PE 6850A polyethylene (Dow Chemical Company) (the “trim blend”). The coextruded five layer film Example 5 was manufactured with a total film basis weight of 25 gsm. The five-layer film was then adhesively laminated on one film surface to one layer of Nonwoven 1 with about 6 gsm of Bostik H2861 adhesive, to make laminate 5A with a structure NW/adh./A/B/C/B/A. One layer of laminate 5A was adhesively laminated to a layer of laminate 4A on the film faces with about 6 gsm of Bostik H2861 adhesive. This created a dual bilaminate 5B with the structure NW/adh/A/B/C/B/A/adh/A/B/A/NW. The dual bilaminate structure 5B had a total NW basis weight of 30 gsm, a total film basis weight of 40 gsm, and a total adhesive basis weight of 12 gsm. The dual bilaminate 5B was then activated on the HSRP at a DOE of 0.250″.

### Example 6

A third comparative example was made by extruding a monolayer film V comprising Vector 4211 SIS film (Dexco Polymers LP). The extruded film V was manufactured with a total film basis weight of 25 gsm. The film V was then adhesively laminated on one film surface to one layer of Nonwoven 1 with about 6 gsm of Bostik H2861 adhesive, to make laminate 6A with a structure NW/adh./V. One layer of laminate 6A was then adhesively laminated on one film surface to laminate 5A with about 6 gsm of Bostik H2861 adhesive. This created a dual bilaminate 6B with the structure NW/adh/V/adh/A/B/C/B/A/adh/NW. The dual bilaminate structure 6B had a total NW basis weight of 30 gsm, a total film basis weight of 50 gsm, and a total adhesive basis weight of 18 gsm. The dual bilaminate 6B was then activated on the HSRP at a DOE of 0.250″.

Table 2 shows the properties comparing dual bilaminates 4B, 5B and 6B.

TABLE 2

| | Example | | |
|---|---|---|---|
| | 4B | 5B | 6B |
| Total Basis Weight before activation (NW + | 66 | 82 | 98 |
| film + adh.) | | | |
| Post Activation Set (%) | 10 | 22 | 7 |

2 Cycle Hysteresis Results (C1 = Cycle 1)

| | | | |
|---|---|---|---|
| C1 Load Force @ 130% strain (N/cm) | 0.81 | 1.42 | 1.09 |
| C1 Unload Force @ 50% strain (N/cm) | 0.16 | 0.15 | 0.17 |
| C1 Unload Force @ 30% strain (N/cm) | 0.09 | 0.06 | 0.07 |
| Permanent set (%) | 8.1 | 9.8 | 6.9 |
| Force Relaxation (%) | 29.7 | 34 | 29.8 |

Tensile Test Results

| | | | |
|---|---|---|---|
| Stretch at 1 N/cm | 215 | 84 | 125 |
| (% engineering strain) | | | |
| Ultimate Tensile Strength (N/cm) | 4.2 | 5.9 | 6.3 |
| Strain at Break | 681 | 547 | 640 |
| (% engineering strain) | | | |
| % RSD for Strain At Break | 22 | 45 | 20 |

By varying the properties of the multilayer laminates, it is possible to create a wide range of materials with unique properties. For instance, double bilaminate Example 4B has comparable properties to Example 6B, despite Example 4B being a lower basis weight structure made from polyolefinic elastomers and Example 6B being a higher basis weight structure incorporating an SBC layer in the film. Also, double bilaminate Example 6B has a very low post activation set (7%). In contrast, Example 5B has a much higher post-activation set (22%). Incorporating both of these laminates in a single sheet material allows for the creation of gathered materials. For example, a strip of 6B could to be laminated over a larger portion of 5B to create a multicomponent laminate 7. If laminate 7 is then activated, regions of the base laminate 5B would gather in and around the area that the strip of 6B is laminated, due to the low post-activation set of 6B and the higher post-activation set of 5B. The amount of gathering in laminate 7 can be controlled by the selection of materials in the various components and by the depth of engagement during activation.

Test Methods

Pinhole Testing—Dye Method

The laminates of Example 1, Example 2, and Comparative Example 1 were tested for pinholes using a standard red dye solution. The laminates were placed flat on clean white paper toweling. A test solution of red dye dissolved in isopropyl alcohol was applied to the surface of the laminates using a sponge roller. After two minutes, the test specimen was carefully removed, taking care to avoid dripping any red dye onto the paper toweling. The white paper toweling under each laminate was then examined for leakage of red dye through the laminate. Such leakage would indicate the presence of activation pinholes.

Pinhole Testing—Visual Method

The laminates of Example 3B and Comparative Example 2 were tested for pinholes using a visual inspection method. The test laminate was stretched to 20% engineering strain (for example, a laminate of 100 mm width is stretched to 120 mm width) and visually inspected under magnification for pinholes. The largest diameter of each hole is measured with a steel rule. The holes are categorized by size based on the length of the largest dimension of the hole. “Tiny” holes are ≦0.5 mm; “small” holes are >0.5 to ≦1.0 mm; “medium” holes are >1 to ≦2 mm; “large” holes are >2 to ≦3 mm; and “extra large” are >3 mm. For the visual test, 20 samples of material measuring 100×100 mm were examined, and the total number of holes in each category was counted. Since the total area of sample examined was 0.2 m2, the number of holes in each category was multiplied by 5 to calculate holes/m2.

Tensile Test

This method was used to determine the force versus strain curve of the materials. The tensile test method is based on ASTM D882-02. Suitable instruments for this test include tensile testers available from MTS Systems Corp. (Eden Prairie, Minn.) or Instron Engineering Corp. (Canton, Mass.). For the test, test specimens of each material with dimensions of 25.4 mm wide by about 100 mm long were cut. The samples were conditioned for at least 1 hour at 23°±2° C. Each specimen was then mounted with the long axis substantially vertical in 2.00 inch wide grips, with a gap of 2.00 inches between the grip faces and no slack in the specimen. The specimen is then stretched by the testing machine at a crosshead speed of 20 inches per minute (50.8 cm/min) to about 1000% elongation or until the sample breaks. A minimum of five specimens are used to determine average test values.

The tensile test results are reported for each material as one or a combination of the following properties: % engineering strain at 1N/cm force (i.e. the elongation at 1N/cm), % engineering strain at break, and the ultimate tensile strength in N/cm (i.e. the peak force divided by the sample width). Engineering strain at 1N/cm force measures how much the laminate can stretch at low forces. The percent engineering strain a break measures how long the laminate can stretch before it breaks. The ultimate tensile strength measures how much force must be exerted on the sample immediately before it breaks.

Engineering strain γtensile is calculated by the following equation:

γtensile={(L/L0)−1}×100

where L0 is the original length, L is the stretched length, and ytensile is engineering strain in units of percent. For example, if a sample with initial length of 5.0 cm is stretched to 15.0 cm, the elongation is 200% engineering strain.

Two Cycle Hysteresis Test

This method is used to determine the stretch-and-recovery properties of the elastomeric materials. The hysteresis test method is based on ASTM D882-02. Suitable instruments for this test include tensile testers available from MTS Systems Corp. (Eden Prairie, Minn.) or Instron Engineering Corp. (Canton, Mass.). For the test, test specimens of each material with dimensions of 25.4 mm wide by about 76.2 mm long were cut. The samples were conditioned for at least 1 hour at 23°±2° C. Each specimen was then mounted with the long axis substantially vertical in 2.00 inch wide grips, with a gap of 1.0 inches (25.4 mm) between the grip faces and no slack in the specimen. For the first cycle of the two-cycle hysteresis test method, the specimen is stretched by the testing machine at a crosshead speed of 13 mm per minute to 5 gram force slack adjustment preload, which defines the adjusted gauge length. Next, the specimen is stretched at a crosshead speed of 10 inches per minute (25.4 cm/min) to the specified engineering strain (e.g. engineering strain=130%). The specimen is held at this specified engineering strain for 30 seconds, then the engineering strain is reduced to 0% engineering strain by returning the grips to the original gauge length at a constant crosshair speed of 25.4 cm/min. The specimen is held for 60 seconds at 0% engineering strain. The specimen is stretched for a second cycle by repeating the first cycle steps. A minimum of five specimens are used to determine average test values.

The hysteresis test results are reported for each specimen for the following properties: Cycle 1 load forces at 100% engineering strain and at 130% engineering strain; Cycle 1 unload forces at 50% engineering strain and at 30% engineering strain; percent set and force relaxation. The forces are reported in N/cm (i.e. force divided by the sample width). The percent set is defined as the percent engineering strain after the start of the second load cycle where a force of 7 grams is measured. Force relaxation is the reduction in force during the Cycle 1 30-sec hold at the specified engineering strain, reported as a percent.

We claim:

1. A multilayer elastomeric laminate, comprising:
a first bilaminate layer comprising a first film layer comprising an elastomeric polymer, and a first substrate layer, wherein the first film layer and the first substrate layer are bonded substantially across the width of the narrowest of the respective layers, wherein the resulting first bilaminate has a first film surface and a first substrate surface; and
a second bilaminate layer comprising a second film layer comprising an elastomeric polymer, and a second substrate layer, wherein the second film layer and the second substrate layer are bonded substantially across the width of the narrowest of the respective layers, wherein the resulting second bilaminate has a second film surface and a second substrate surface,
wherein the first bilaminate layer and the second bilaminate layer are adhesively bonded together so that said first and second film surfaces face each other, and
wherein each of the first and second bilaminate layers is preformed as a separate precursor layer, prior to being adhesively bonded together, with the first and second bilaminate layers each having a total film basis weight less than about 30 gsm.

2. The multilayer elastomeric laminate according to claim 1 wherein said first film layer and said first substrate layer of the first bilaminate and said second film layer and said second substrate layer of the second bilaminate are bonded by extrusion lamination, adhesive lamination, thermal lamination, ultrasonic lamination, calender lamination, or combinations thereof.

3. The multilayer elastomeric laminate according to claim 1 wherein said first bilaminate and said second bilaminate are adhesively bonded together by adhesive lamination.

4. The multilayer elastomeric laminate according to claim 1 wherein said first and second bilaminates comprise the same film and substrate layer components.

5. The multilayer elastomeric laminate according to claim 1 wherein said first and second bilaminates comprise different film and/or substrate layer components.

6. The multilayer elastomeric laminate according to claim 1 wherein the first film layer, the second film layer, or both comprise multilayer films.

7. The multilayer elastomeric laminate according to claim 1 wherein the first elastomeric film and the second elastomeric film comprise one or more elastomeric polymers selected from the group consisting of styrenic block copolymers, polyolefinic elastomers, combinations thereof, and blends thereof.

8. The multilayer elastomeric laminate according to claim 1 wherein the first substrate layer and the second substrate layer comprise nonwoven fabrics.

9. The multilayer elastomeric laminate according to claim 1 wherein the multilayer elastomeric laminate is activated.

10. The multilayer elastomeric laminate according to claim 1 having a post activation set less than about 25%.

11. The multilayer elastomeric laminate according to claim 1 having a permanent set less than about 15%.

12. The multilayer elastomeric laminate according to claim 1 wherein a number of pinholes of a size between about 0.5 and 3.0 mm is less than about 30 pinholes per square meter after the laminate is activated.

13. The multilayer elastomeric laminate according to claim 1 wherein the first and second bilaminate layers each have a total film basis weight less than about 20 gsm.

14. A method of making a multilayer elastomeric laminate, comprising
forming a first bilaminate layer comprising a first elastomeric film layer and a first substrate layer by bonding the first elastomeric film layer and first substrate layer substantially across the width of the narrowest of the respective layers, wherein the resulting first bilaminate layer has a first film surface and a first substrate surface;
separately forming a second bilaminate layer comprising a second elastomeric film layer and a second substrate layer by bonding the second elastomeric film layer and second substrate layer substantially across the width of the narrowest of the respective layers, wherein the resulting second bilaminate layer has a second film surface and a second substrate surface; and
adhesively bonding together the first bilaminate layer and the second bilaminate layer so that said first and second film surfaces face each other, and wherein the first and second bilaminate layers each have a total film basis weight less than about 30 gsm.

15. The method according to claim 14, wherein said first film layer and said first substrate layer of the first bilaminate and said second film layer and said second substrate layer of the second bilaminate are bonded by extrusion lamination, adhesive lamination, thermal lamination, ultrasonic lamination, calender lamination, or combinations thereof.

16. The method according to claim 14 wherein said first bilaminate and said second bilaminate are adhesively bonded together by adhesive lamination.

17. The method according to claim 14 wherein the first film layer, the second film layer, or both comprise multilayer films.

18. The method according to claim 14 wherein the first substrate layer and the second substrate layer comprise nonwoven fabrics.

19. The method according to claim 14 further comprising activating the multilayer elastomeric laminate.

20. The method according to claim 19 wherein a number of pinholes of a size between about 0.5 and 3.0 mm is less than about 30 pinholes per square meter after the laminate is activated.
